(19) United States
(12) Patent Application Publication
(10) Pub. No.: US 2014/0279568 A1
(43) Pub. Date: Sep. 18, 2014

(54) PRICE NEGOTIATION METHOD AND SYSTEM

(71) Applicant: VARIAB.LY LTD, Shatin (HK)

(72) Inventors: George COTSIKIS, Athens (GR); Nick JENNINGS, Hampshire (GB); Christoforos ANAGNOSTOPOULOS, London (GB)

(73) Assignee: VARIAB.LY LTD, Shatin (HK)

(21) Appl. No.: 14/212,743

(22) Filed: Mar. 14, 2014

Related U.S. Application Data
(60) Provisional application No. 61/789,377, filed on Mar. 15, 2013.

(51) Int. Cl. G06Q 50/18; G06Q 30/02

(52) U.S. Cl. CPC G06Q 50/188; G06Q 30/0283
USPC 705/80

(57) ABSTRACT

The present invention relates to a method for generating proposals in a negotiation, the method including an automatic agent calculating a proposal in accordance with a predetermined function using one or more variables, transmitting the proposal to another agent across a communications channel, and receiving a counter-proposal from the other agent. The variables include a loyalty parameter and/or a reputation parameter. A system for negotiation is also disclosed.

### CROSS REFERENCE TO RELATED APPLICATION

This application is based on and claims the benefit of priority from U.S. Provisional Patent Application No. 61/789,377, filed Mar. 15, 2013, the disclosure of which is incorporated herein in its entirety by reference.

### FIELD OF INVENTION

The present invention is in the field of price negotiation. In particular, but not exclusively, the present invention relates to a method for use of an automatic agent in proposal (bid or offer) generation within a negotiation process.

### BACKGROUND

The process of counterparty & price discovery is the main role of marketplaces.

Exchanges from ancient times until today exist to facilitate the process of connecting parties that are willing to exchange goods at a utility maximising price & quality/quantity for both parties.

Price negotiation has also been prominent in marketplaces throughout the ages. In most marketplaces, a context-specific negotiation process between buyers and sellers (or coalitions thereof) will outperform a pure fixed price system as a price discovery mechanism. The context for negotiations include location, time, reputation (of buyer and seller), loyalty, price, and preferences. Discounts, auctions, and ‘flash/group’ sales are special cases where the buyer is not given the opportunity to counter-bid.

In the online sphere, Amazon™ provides an example of a standard ecommerce system which provides fixed prices for goods with personalization options.

Groupon™ and LivingSocial™ are examples of coupon-based process which provide for deep fixed discounts and group buying.

Craigslist™ is an example of online classifieds providing localized newspaper-style classifieds combined with an ecommerce mechanism.

eBay™ is an example of an online public auction where the sellers have a visible reputation.

None of the above options provide for dynamic and personalized pricing. Deep discounts have proven to be disadvantageous for most merchants as the merchants are unable to manage the quality of their customers, suffer spikes of customer quantity and are usually loss making. Some of these options have local options but are not true peer to peer mechanisms. In short they are subsets of what an effective marketplace could look like.

Negotiation overcomes the two main problems of auctions: (i) prices cannot be changed during auction process in the light of new information and (ii) the winner's curse—in the presence of symmetric information the winner of an auction will have to pay more than “fair” value to win. There exist some auction protocols that minimize these problems, such as Vickrey auctions, but they are counterintuitive.

Negotiations are essentially a two-sided dynamic auction. Stock exchanges are examples of fast negotiations. As long as both parties maximize utility (seller maximizes revenue and buyer maximizes savings) the outcome is a more efficient marketplace.

There is a desire for an, at least partially, automated online negotiation system which provides an efficient mechanism for price discovery.

It is an object of the present invention to provide a negotiation method and system which overcomes the disadvantages of the prior art, or at least provides a useful alternative.

### SUMMARY OF INVENTION

According to a first aspect of the invention there is provided a computer-implemented method for generating proposals in a negotiation, including:

an automatic agent calculating a proposal in accordance with a predetermined function using one or more variables, transmitting the proposal to another agent across a communications channel, and receiving a counter-proposal from the other agent; wherein the variables include one or more from the set of a loyalty parameter and a reputation parameter.

The communications channel may be a private communications channel.

The proposal may be delimited by a reservation value.

The loyalty parameter may be based upon previous transactions between the participants to the negotiation and the reputation parameter may be based upon all previous transactions from one of the participants to the negotiation.

The predetermined function may be a linear function, a non-linear function, or a look-up table.

The predetermined function may include changing the reservation value. The reservation value may be increased by the predetermined function to incorporate a discount or decreased by the predetermined function to incorporate a premium.

A plurality of consecutive proposals and counter-proposals creates a negotiation thread, and the proposals and counter-proposals preferably converge over time.

Random variation may be introduced to the value of at least one of the proposals by the automatic agent to inhibit the other agent from calculating the predetermined function.

Random variation may be introduced to the timing of at least one of the proposals by the automatic agent to inhibit the other agent from calculating the predetermined function.

The automatic agent may generate further proposals only if the further proposals are within a predefined time limit for the entire negotiation thread or the automatic agent may generate further proposals only if the further proposals are within a predefined total number of proposals for that software agent for the entire negotiation thread. Neither the time limit or total proposal limit may be known by the other agent.

The one or more variables may further include one or more selected from the set of suggested price, suggested initial bid (proposal), time limit for the negotiation, location of a service to which the bid (proposal) relates and quality of an item to which the bid (proposal) relates.

These further variables may be known by both the automatic agent and the other agent.

The other agent may also be an automatic agent. The other agent may calculate a counter-proposal to a received proposal in accordance with a predetermined function using one or more variables, and transmits the counter-proposal to the automatic agent across a communications channel.

The automatic agent may operate within a negotiation system comprising a plurality of automatic agents. The reputation parameter may known to all automatic agents, and the loyalty parameter may be known between the automatic agent and the other agent, and not known by the other automatic agents.

The variables may be bounds and normalised within their bounds.

The proposal and counter-proposal may be transmitted via a central server.

The one or more variables may include a dynamic variable, such as the current thread of proposals and counter-proposals for the negotiation.

The automatic agent may be one of a plurality of agents negotiating with the another agent and the accepted proposal for the automatic agent is a function of all final proposals from the plurality of agents, or the automatic agent may be negotiating with a plurality of agents and the accepted proposal is a function of all final proposals with the plurality of agents.

According to a further aspect of the invention there is provided an automatic agent comprising:

processing circuitry configured for calculating a proposal in accordance with a predetermined function using one or more variables; wherein the variables include one or more from the set of a loyalty parameter and a reputation parameter;
storage circuitry configured for retrieving the one or more variables; and communications circuitry for transmitting a proposal to another agent across a communications channel and receiving a counter-proposal from the other agent.

According to a further aspect of the invention there is provided a server configured to facilitate communications between a plurality of agents, at least one of the agents being an automatic agent as in the aspect above.

The server may further include storage circuitry configured to store a reputation parameter for at least one of the agents.

According to a further aspect of the invention there is provided a system comprising:

at least one automatic agent; and
a communications network.

Other aspects of the invention are described within the claims.

### BRIEF DESCRIPTION OF THE DRAWINGS

Embodiments of the invention will now be described, by way of example only, with reference to the accompanying drawings in which:

FIG. 1: shows a hardware diagram of aN automatic agent in accordance with an embodiment of the invention;

FIG. 2: shows a diagram of a negotiation system in accordance with an embodiment of the invention;

FIG. 3: shows a flowchart illustrating a negotiation method for one automatic agent in accordance with an embodiment of the invention;

FIG. 4: shows a flowchart illustrating a negotiation method between two automatic agents in accordance with an embodiment of the invention;

FIG. 5: shows a first graph illustrating use of an exemplary function in accordance with an embodiment of the invention;

FIG. 6: shows a second graph illustrating use of an exemplary function in accordance with an embodiment of the invention;

FIG. 7: shows a third graph illustrating use of an exemplary function in accordance with an embodiment of the invention;

FIG. 8: shows a fourth graph illustrating use of an exemplary function in accordance with an embodiment of the invention;

FIG. 9: shows a fifth graph illustrating use of an exemplary function in accordance with an embodiment of the invention;

FIG. 10: shows a sixth graph illustrating use of an exemplary function in accordance with an embodiment of the invention;

FIG. 11: shows a seventh graph illustrating use of an exemplary function in accordance with an embodiment of the invention;

FIG. 12: shows an eighth graph illustrating use of an exemplary function in accordance with an embodiment of the invention;

FIG. 13: shows a ninth graph illustrating use of an exemplary function in accordance with an embodiment of the invention;

FIG. 14: shows a tenth graph illustrating use of an exemplary function in accordance with an embodiment of the invention;

FIG. 15: shows an eleventh graph illustrating use of an exemplary function in accordance with an embodiment of the invention; and

FIG. 16: shows a twelfth graph illustrating use of an exemplary function in accordance with an embodiment of the invention.

### DETAILED DESCRIPTION OF PREFERRED EMBODIMENTS

The present invention provides a price negotiation method and system using automatic agents.

Loyalty measures “repeat business” between a buyer and a seller and can drive personalised pricing methodologies—integration of “loyalty points” within the negotiation mechanism seamlessly enables immediate and relevant monetary rewards via discounts and offers. Loyalty is a private or public pair-wise attribute that a seller assigns to a repeat buyer.

Reputation is a global metric across the trading counterparties and increases with successful interaction within the community. Highly reputable counterparties will attract business and gain from network dynamics. Reputation is a public attribute that can be attached to both buyers and sellers.

Collective Behaviour/Coalition Formation is buyers grouping together to secure better deals. Sellers can also produce joint offers, or share loyalty schemes with other sellers that are not in direct competition with them, hence engaging a larger pool of customers.

The inventor has discovered that use by an automatic agent within a negotiation system of a combination of one or more of the above concepts can produce a more efficient marketplace for buyers and sellers.

In FIG. 1, an automatic agent 100 for a price negotiation method and system in accordance with an embodiment of the invention is shown.

The agent includes processing circuitry 101, storage circuitry 102, and communications circuitry 103.

The storage circuitry 102 is configured to retrieve one or more variables. The storage circuitry 102 may retrieve the variables from a local database or from a remote database stored on a server. The one or more variables may include loyalty information, reputation information, or other information, such as location, item quality, and a publicly known time horizon for the negotiation.

The processing circuitry 101 is configured to calculate a proposal with a predetermined function using the one or more variables retrieved by the storage circuitry. The function may be a linear or non-linear function. Examples of possible functions will be described later in this document. The proposal is a bid for the purchase of goods or services or an offer for the sale of goods or services within a negotiation with another party. It can envisaged that other exchanges may take place, for example a license or lease of a good or service.

The communications circuitry 103 may be configured to transmit that calculated proposal to the other party over a communication channel, and to receive a counter-proposal from that other party.

The processing circuitry 101 may be configured for concluding the negotiation as a success if the counter-proposal meets or exceeds the next calculated proposal. The processing circuitry 101 may be configured for concluding the negotiation as a failure if the counter-proposal is not received by one or more thresholds such as within a predefined time horizon for the negotiation known by both parties, a predefined time horizon for the negotiation not known by the other party, a predefined total number of proposals and/or counter-proposals which may not be known by the other party, and/or if the next calculated proposal exceeds a predefined reservation value which may not be known by the other party.

A reservation value is the maximum a buyer is willing to pay or the minimum a seller is willing to sell at.

It will be appreciated that the automatic agent 100 may be implemented as software executing upon hardware, or within hardware itself. It will further be appreciated that software may execute upon hardware via a virtual layer and the hardware may comprise multiple components connected by a communications network.

In FIG. 2, a system 200 for negotiation in accordance with an embodiment of the invention is shown.

The system 200 may comprise a plurality of automatic agents 201 and 202 as described in relation to FIG. 1. The system also comprises a communications network 203.

An automatic agent 201 may be configured to transmit and receive proposals/counter-proposals to another automatic agent 202 acting for the other party or to a device 204 in the control of the other party. Accordingly, counter-proposals may be calculated by the other automatic agent 202 or generated by the other party themselves.

The proposals/counter-proposals may be transmitted through the communications network 203 via communications channels. Preferably the communications channels are private which ensures that third parties cannot detect negotiation strategies used by the parties to the negotiation. The communications channels may be peer-to-peer, or they may travel via a central server 205 which coordinates the negotiation. It will be appreciated that other configurations of the communications channels may be possible.

The central server 205 may be configured to store public information about the parties to the negotiation. For example, the central server 205 may store reputation information about the parties and permit the parties to access the reputation information for use by the automatic agents 201 and 202 in calculating proposals.

A computer-implemented method 300 for generating proposals will now be described with reference to FIG. 3.

An automatic agent may utilises one or more variables, such as loyalty of the other party or the reputation of the other party, within a predetermined function to calculate a proposal for a good or service offered to or supplied by the other party in step 301.

The calculated proposal is transmitted to the other party in step 302, and a responsive counter-proposal is received from the other party in step 303.

A method 400 for conducting a negotiation between two automatic agents in accordance with an embodiment of the invention will now be described with reference to FIG. 4.

A first automatic agent acting for a first party to the negotiation calculates a proposal in step 401 and transmits it to a second automatic agent acting for a second party to the negotiation in step 402.

The second automatic agent after receiving the proposal in step 403, calculates a counter-proposal in step 404, and transmits it to the first automatic agent in step 405.

The first automatic agent receives the counter-proposal in step 406 and the process repeats in step 407 until the proposal or counter-proposal is accepted by either automatic agent or until a threshold, such as a reservation value for either automatic agent, is reached.

The proposal or counter-proposal may be accepted where the next proposal or counter-proposal would equal or progress beyond the corresponding counter-proposal or proposal.

An exemplary implementation of the invention will now be described with reference to FIGS. 5 to 16.

In this implementation, an interface presents a list of items on sale by various sellers, and allows any potential buyer to enter a peer-to-peer negotiation with each such seller. The negotiation strategy is automatically decided by the system, on the basis of information specified by both the buyer and the seller. Critical information remains private, and is never made available to the other negotiating party or his/her device. In this manner, the negotiation strategy is fair to both parties.

Basic Terminology

S denotes the seller of an item and B denotes the buyer. The following information may be required for each item, and may be publicly available to anyone accessing the service:
Public information for each item-seller combination:
   Suggested Retail Price (SRP) and Suggested Initial Bid (SIB)
   negotiation time horizon, tmax
   seller reputation rS (which is a global property)
   location (which may be particularly advantageous for services)
   item quality (which may be relevant in certain verticals such as hotel or restaurant bookings)

Once a buyer B decides to enter a negotiation with S, the following pieces of information may be assumed to be known to both B and S:
Information available to the two negotiating parties
   the buyer's loyalty to this seller, IS,B (pairwise property)
   the buyer's location vis-à-vis the seller's (distance)

Finally, the following may be also need to be specified by either negotiating party, but remain private to that party (for example, it may be locally stored on their device):
Information private to the seller:
   seller time horizon tS<tmax (maximum time)
   seller reservation value, RS (minimum price)
   maximum number of offers, NS
Information private to the buyer:
   the buyer's time horizon, tB<tmax (maximum time)
   the buyer reservation value, RB (minimum price)
   maximum number of bids, NB

These parameters are selected so that the buyer and seller may easily specify them, without needing to explicitly define what their preferred negotiation strategy is. The negotiation strategy is then recovered from these parameters, as explained in the following. Firstly, a negotiation thread consists of a sequence of time-ordered offers (a proposed price from S to B) and bids (a proposed price from B to S). Offers and bids (jointly referred to as proposals) strictly succeed one another, as follows:

oₖ=(p₂ₖ,t₂ₖ),bₖ=(p₂ₖ₊₁,t₂ₖ₊₁), . . . .

and satisfy the following:
tᵢ<tᵢ₊₁<min(t_{B},t_{S}) (time ordering)
pᵢ₊₁>pᵢ₋₁pᵢ₊₁>pᵢ₋₁ (bid prices increase over time)
pᵢ<pᵢ₋₂ (offer prices decrease over time)

A negotiation thread continues until the time horizon is exceeded, or pᵢ<pᵢ₊₁ for some i, in which case it is said to be successful.

Linear Negotiation Strategies

Non-adaptive negotiation strategies will now be described (i.e., strategies where the sequence of offers does not depend on the sequence of bids, and vice versa, excepting the termination criterion). This is the baseline strategy.

Firstly linear strategies that linearly traverse the whole range of acceptable prices within each agent's time horizon, until consensus is reached, or the time horizon of either party is exceeded:

$$\begin{matrix}o ( t ) = SRP - ( \frac{t - {t}_{0}}{{t}_{s} - {t}_{0}} ) ( SRP - {R}_{S} ) so that o ( {t}_{0} ) = SRP , o ( {t}_{S} ) = {R}_{S} & ( A ) \\ b ( t ) = SIB - ( \frac{t - {t}_{0}}{{t}_{B} - {t}_{0}} ) ( {R}_{B} - SIB ) so that b ( {t}_{0} ) = SIB , b ( {t}_{B} ) = {R}_{B} & ( B )\end{matrix}$$

The negotiation paths from this strategy are shown in FIG. 5. The negotiation ends successfully in the neighbourhood of the intersection of the bidding and offering paths. The simplest possible offer/bid sequence is constructed by having proposals occur at regular intervals. Variants of this strategy will now be considered.

Incorporating Reputation, Loyalty, and Other Parameters

Variables such as account reputation, loyalty, location, item quality, and possibly other characteristics likely to affect the appeal of a seller-item combination to a buyer, or vice versa can be utilised by the strategy. There are two ways of incorporating such parameters into the negotiation strategy algorithm: a non-linear method, and a linear method. These techniques will firstly be described generally and then it will be described how specific factors of interest may be suitably encoded.
Nonlinear parameter-dependent negotiation strategies

Equations (A) and (B) can generalised in order to take into account factors that may make a certain item more appealing to the buyer, or a certain buyer more appealing to the seller. A parameter θ_{S,B}^{S} is specified which encodes the appeal of this particular deal to the seller (for reasons other than price—e.g., rewarding repeat business from a loyal customer), and similarly, a parameter θ_{S,B}^{S} is specified which encodes the appeal of the deal to the buyer (e.g., due to proximity, or the reputation of the seller). The buyer/seller may specify either parameter.

Either parameter takes values in the continuous interval starting from −1 and ending at 1, with 0 indicating neutral, i.e., indicating no special preference.

The following families of curves can then be considered:

o_{θ}(t)=f(θ_{S,B}^{S},t),b_{θ}=g(θ_{S,B}^{S},t)

where the subscript θ emphasises the possibly non-linear form of the curve, and distinguishes it from the linear bid and offer paths of the previous section.

The following properties must also hold:
o₆(t₀)=SRP, o_{θ}(t_{S})=R_{S}, and b_{θ}(t₀)=SIB, b_{θ}(t_{S})=R_{B}, as before. This ensures that the endpoints of the curves agree with the linear case.
o_{θ}(t) is monotonically increasing, and b_{θ}(t) monotonically decreasing in t, for all values of θ. This ensures that bids increase, and offers decrease.
for O_{SB}^{S}=0, f(0, t₀)=o(t₀) and for θ_{S,B}^{B}=0, g(0, t₀)=b(t₀). In other words, when the preference is neutral, the linear case is reverted to.
for θ_{S,B}^{S}=−1, f(−1,t)=SRP for all t, and for θ_{S,B}^{S}=+1, f(+1, t)=R_{S}. In other words, an extremely unappealing buyer is only ever offered the SRP, whereas an extremely appealing buyer is immediately offered the reservation value of the seller.
for θ_{S,B}^{B}=−1, g(−1, t)=SIB for all t, and for θ_{S,B}^{B}=+1, g(1, t)=R_{B}. In other words, an extremely unappealing seller-item combination only ever gets the SIB, whereas for an extremely appealing seller-item combination, the buyer immediately bids his/her reservation value.

One simple example that will be used henceforth is the following pair of functions:

$$f ( θ , t ) = SRP - {( \frac{t - {t}_{0}}{{t}_{s} - {t}_{0}} )}^{ψ ( θ )} ( SRP - {R}_{S} ) , \\ g ( θ , t ) = SIB + {( \frac{t - {t}_{0}}{{t}_{s} - {t}_{0}} )}^{ψ ( θ )} ( {R}_{B} - SIB )$$

where

$$ψ ( θ ) = \frac{1 - θ}{1 + θ} ,$$

so that:
θ=+1 means ψ(θ)=0 which in turn means that

$${( \frac{t - {t}_{0}}{{t}_{s} - {t}_{0}} )}^{ψ ( θ )} = 1 ,$$

so that we get f(θ,t)=SRP−(SRP−R_{S})=R_{S} and g(θ, t)=SIB+(R_{B}−SIB)=R_{B}.
θ=0 means ψ(θ)=1 which in turn means that

$${( \frac{t - {t}_{0}}{{t}_{s} - {t}_{0}} )}^{ψ ( θ )} = ( \frac{t - {t}_{0}}{{t}_{s} - {t}_{0}} ) ,$$

so

$$f ( θ , t ) = SRP - ( \frac{t - {t}_{0}}{{t}_{s} - {t}_{0}} ) ( SRP - {R}_{S} )$$

and similarly for g.
θ=−1 means ψ(θ)=∞ (in practise, a very large number), which means that

$${( \frac{t - {t}_{0}}{{t}_{s} - {t}_{0}} )}^{ψ ( θ )} = 0 ,$$

to get f(θ, t)=SRP and g(θ,t)=SIB.

In general, the two parameters θ_{S,B}^{B}, θ_{S,B}^{S} can depend on several factors of interest. To take a simple example, assume that the system tracks the reputation, r_{S}, of each seller, which is measured via positive feedback from previous buyers; and the loyalty, l_{B,S}, of each buyer to each seller, which is measured by the extent of repeat business this seller gets from that buyer.

Let's further assume that both reputation and loyalty scores are given in percentages, i.e., numbers between 0 and 100. Then the following may be set:

θ_{S,B}^{B}=r_{S}/100,θ_{S,B}^{S}/100

This way, reputable sellers and loyal customers will be favoured, but no seller/customer will be treated worse than linear. This convention will be adopted hereafter, but it is not necessary for the system. The effect of this choice is shown in FIG. 6 (θ_{S,B}^{B}=0,θ_{S,B}^{S}=0.17), FIG. 7 (θ_{S,B}^{B}=0.17, θ_{S,B}^{S}=0), and FIG. 8 (θ_{S,B}^{B}=0.17, θ_{S,B}^{S}=0.17). Qualitatively, it may be observed that:
a buyer will accept a higher price, and sooner, from a reputable seller
a seller will accept a lower price, and sooner, to a loyal buyer
a loyal buyer against a reputable seller may end up agreeing on the same price as in the general case, but will reach this agreement earlier

Similarly, location may be incorporated as follows:

$${θ}_{S , B}^{B} = {w}_{r} ( {r}_{s} / 100 ) + {w}_{d} ( \frac{{d}_{max} - {d}_{S , B}}{{d}_{max}} )$$

where d_{S,B} is the distance between the item-seller in question and the buyer, and dₘₐₓ is the maximum distance the buyer is prepared to travel (so that an earlier check in the system ensures that if d_{S,B}>dₘₐₓ the negotiation never even starts); and the weights wᵣ+w_{d}=1 represent the relative importance of proximity over seller reputation for this particular buyer (i.e., may be specified by the user). In this way as many additional factors may be incorporated into the system, as long as the features can be normalised between 0 and 1 (or −1 and 1, as required).
Linear parameter-dependent negotiation strategies

An alternative to curved negotiation paths is to have θ_{S,B}^{B}, θ_{S,B}^{S} affect the reservation value instead. This is achieved as follows:
set R_{S}*=R_{S}−(1−θ_{S})m_{S}R_{S}, where m_{S} is the maximum additional discount a seller is prepared to offer to a loyal customer.
Similarly set R_{B}*=R_{B}+(1−θ_{B})m_{B}R_{B}, where m_{B} is the maximum additional premium a buyer is prepared to offer to a reputable seller.

In FIGS. 9, 10 and 11 this alternative demonstrates exactly the same qualitative effect as the parametric curves of the previous section. A combination of both lower reservation values and shape-adjustments is also possible. The non-linear curves have the advantage that it is harder to reverse-engineer the negotiation curves. Moreover, although the change in the reservation value is more easily interpretable, so that at first instance it is easier to explain the functionality to the user, by the same token, buyers/sellers may be reluctant to make use of the functionality if they understand it in terms of an amended reservation value. In contrast, non-linear curves respect the user's stated reservation value, while simultaneously allowing flexible negotiating.

Constructing the Offer/Bid Sequence

Proposals may be generated across the time horizon. It may be beneficial to minimise the number of proposals for communication purposes.
Firstly, the minimum change between proposals are constrained:

|pᵢ₊₁−pᵢ|>δₚ
where δₚ is determined by the system and is public information, as are the SRP and the SIB. It could be set to 5 GBP, or as a percentage of SRP-SIB.
The seller has their own private “maximum number of offers” N_{S}, and the buyer analogously has a private “maximum number of bids”, N_{B}. These are free in manual mode, or are set by the system in automatic mode, by dividing the buyer/seller price ranges by twice the minimum proposal increment (to ensure that proposal increments are not always equal to δₚ):

$${N}_{S} \approx \frac{SRP - {R}_{S}}{2 {δ}_{p}} , {N}_{B} \approx \frac{{R}_{B} - SIB}{2 {δ}_{p}}$$

N_{S} and N_{B} are private to the seller/buyer respectively. This is to ensure reverse-engineering of their reservation values is more difficult harder.
As time progresses, buyers/sellers keep track of the bids/offers they have placed, ensuring that:
   Each proposal changes the price by at least δₚ
   At each round, the buyer/seller will wait a certain amount of time before they place their next proposal. The length of this interval is decided by dividing the time remaining until their horizon by the number of their remaining bids/offers or the length of time required for the price to change by at least δₚ, whichever is longest.

In algorithmic format, the negotiation is given by:
o₀=(SRP, t₀), b₀=(SiB, t₀)
for i=2k (i.e., an even round), the seller places offer oₖ=(o(t₂ₖ),t₂ₖ), leaving him/her N_{S}−k offers left for future rounds. The time t₂ₖ is:

$${t}_{2 k} = {t}_{2 k - 1} + max \{ \frac{{t}_{S} - {t}_{2 k - 1}}{{N}_{S} - k} , inf \{ δ \vert o ( {t}_{2 k - 1} + δ ) - {o}_{k - 1} > {δ}_{p} \} \}$$

for i=2k+1 (i.e., an odd round), the buyer places bid bₖ=(b(t₂ₖ₊₁), t₂ₖ₊₁), leaving him/her N_{B}−k bids left. The time t₂ₖ₊₁ is given by:

$${t}_{2 k + 1} = {t}_{2 k} + max \{ \frac{{t}_{B} - {t}_{2 k}}{{N}_{B} - k} , inf \{ δ \vert b ( {t}_{2 k} + δ ) - {b}_{k - 1} > {δ}_{p} \} \}$$

if either N_{S}=k or N_{B}=k or tᵢ>min{t_{S},t_{B},tₘₐₓ} or bₖ≧oₖ, the negotiation completes (successfully in the latter case only).

### Example

Consider an example with:
SRP=150, R_{S}=100, t_{S}=90
SIB=50, R_{B}=135, t_{B}=60
t₀=1,tₘₐₓ=100, r_{S}=0, l_{B,S}=0
δₚ=0.02(SRP−SIB)=3 which means that N_{S}=17, N_{B}=29

The algorithm then progresses as follows:

### Offer 2: (143,11)

### Bid 2: (72,15)

### Offer 3: (136,25)

### Bid 3: (90,28)

### Offer 4: (129,37)

### Bid 4: (106,39)

### Offer 5: (123,48)

### Bid 5: (120,49)

### Offer 6: (120,56)

Negotiation Concluded Successfully

The sequence of bids and offers is shown graphically in FIG. 12. Setting now the loyalty of the buyer to 0.17, the following modified sequence of bids/offers, is shown graphically in FIG. 13, which of course results in a better price for the buyer:

### Offer 2: (123,11)

### Bid 2: (72,15)

### Offer 3: (115,25)

### Bid 3: (90,28)

### Offer 4: (111,38)

### Bid 4: (107,40)

### Offer 5: (107,52)

Negotiation Concluded Successfully

If the seller is also reputable, the following sequence of bids is obtained, resulting in a similar price to the default setup, but agreed to much earlier (18 minutes rather than 55). This is shown in FIG. 14.

### Offer 2: (123,11)

### Bid 2: (123,15)

Negotiation Concluded Successfully

Predictability of the Negotiation Strategy

To make reverse engineering harder, random variation may be added to either the proposed price, or its timestamp, as the combination of these two pieces of information, together with knowledge of the shape of the curve (which may become apparent with time), allows one to estimate the entire negotiation curve. Noising up the timestamps may be more advantageous, since the prices are themselves the object of interest and should hence may be best not randomised. The following modification of the algorithm at round k implements randomisation of the time-stamps:

$${t}_{2 k} = {t}_{2 k - 1} + ɛmax \{ \frac{{t}_{S} - {t}_{2 k - 1}}{{N}_{S} - k} , inf \{ δ \vert o ( {t}_{2 k - 1} + δ ) - {o}_{k - 1} > {δ}_{p} \} \}$$

$${t}_{2 k + 1} = {t}_{2 k} + ɛmax \{ \frac{{t}_{B} - {t}_{2 k}}{{N}_{B} - k} , inf \{ δ \vert b ( {t}_{2 k} + δ ) - {b}_{k - 1} > {δ}_{p} \} \}$$

where ε is a number chosen uniformly at random from the interval [0,2]. In other words, the next proposal is sent a little earlier, or a little later by a random amount of time. FIG. 15 illustrates a negotiation generated in accordance with randomised timestamps and it can be seen the increased difficulty in “guessing” the true negotiation curve. Repeating this ten times yields the following completion prices and timestamps:
112, 47
108, 51
109, 49
108, 56
108, 57
110, 45
108, 53
110, 53
108, 54
108, 51

There is some variation in the data above, but not much. On average the price agreed is 109 and average time 52 with standard deviations of 1.3 and 3.8 respectively, where the non-randomised deal was (107,52).

Binding Nature of Offers/Bids

At any given time, either the buyer or the seller can exit a negotiation. The system notifies the counterparty if this happens. Consequently, as long as a negotiation is active, either the buyer or seller can accept a deal. A deal only becomes binding once the seller's (resp. buyer's) agent confirms to the buyer's (resp. seller's) agent receipt of their willingness to make a deal at that price:
offer made, pending reply from buyer
bid made, pending reply from seller
offer accepted, message sent to seller—buyer is bound until seller confirms receipt (and for a maximum of 5 minutes)
bid accepted, message sent to buyer—seller is bound until seller confirms receipt (and for a maximum of 5 minutes)

The above implementation can include a number of variations including:

Instead of a liner or non linear closed functional form the negotiation thread price paths over time may be represented as pairwise mapping tables where each time t maps to a predetermined and stored value of price o(t) and b(t) (or discount/premium). The process of calculation is then replaced by a process of table lookup. This can be considered as a special case of a predetermined function. In case of a time t lookup not represented in the table (i.e. second 1.5 when only second 1 & 2 are represented) the lookup value may be calculated on the fly via linear interpolation of the values corresponding to the 2 adjacent stored values. The benefit of such a process is the decoupling of the functional from the negotiation thread process, something that gives bigger flexibility in describing negotiation thread price paths over time. A look-up table is shown in FIG. 16. This Figure illustrates multiple look up tables in one graph for different parameter values.

Furthermore, adaptive functions may wish to take into account as input other dynamic variable including the other side's behaviour in order to adapt responses in a game theoretic way. One way to incorporate adaptive behaviour in the formalism developed above is to incorporate a negotiation thread memory vector where the buyer stores o(t) and the seller stores b(t). That vector of prices and its derivatives (i.e. first derivative speed of change) and statistical moments (i.e. mean, range, skew, etc.) can be mapped into a [0,1] range θb and θs, hence dynamically changing the negotiation thread as they get updated. As an example a buyer that sees o(t) rate of decline to be rapid may with to incorporate this information by a suitable mapping in θb to decrease his speed of bid increases (the slope of b(t)). Any kind of complex behaviour can be modelled this way by adding other adaptive exogenous factors that can dynamically shape the negotiation thread on the fly.

Lastly, collective negotiation may be provided for in one embodiment. Agents can choose to set a flag indicating the willingness to engage in the negotiation process with groups. In essence the negotiation threads still remain as before but once the group has finished negotiation the final price is a function of the achieved prices (min, max, median, etc.).

The group can be defined by inviting manually (i.e. a buyer invites other agents to negotiate on a deal) or automatically via clustering based on time/location/other parameters. The group negotiation can be both for group buying and group selling and aims to achieve efficiencies with scale (more buyers better average price for them, more inventory offload for seller). So if we have n negotiation threads once all the parties finish successful negotiation (ones who do not do not participate) the final price is determined as a function of all achieved prices.

A potential advantage of some embodiments of the present invention is that the buyer and seller can negotiate between themselves easily and quickly to conclude an efficient transaction.

While the present invention has been illustrated by the description of the embodiments thereof, and while the embodiments have been described in considerable detail, it is not the intention of the applicant to restrict or in any way limit the scope of the appended claims to such detail. Additional advantages and modifications will readily appear to those skilled in the art. Therefore, the invention in its broader aspects is not limited to the specific details, representative apparatus and method, and illustrative examples shown and described. Accordingly, departures may be made from such details without departure from the spirit or scope of applicant's general inventive concept.

1. A computer-implemented method for generating proposals in a negotiation, including:
an automatic agent calculating a proposal in accordance with a predetermined function using one or more variables, transmitting the proposal to another agent across a communications channel, and receiving a counter-proposal from the other agent;
wherein the variables include one or more from the set of a loyalty parameter and a reputation parameter.

2. A method as claimed in claim 1 wherein the communications channel is a private communications channel.

3. A method as claimed in claim 1 wherein the proposal is delimited by a reservation value.

4. A method as claimed in claim 1 wherein the loyalty parameter is based upon previous transactions between the participants to the negotiation.

5. A method as claimed in claim 1 wherein the reputation parameter based upon all previous transactions from one of the participants to the negotiation.

6. A method as claimed in claim 1 wherein the predetermined function is a linear function, a non-linear function, and/or a look-up table.

7. A method as claimed in claim 1 wherein the predetermined function includes changing the reservation value to incorporate a discount or to incorporate a premium.

8. A method as claimed in claim 1 wherein a plurality of consecutive proposals and counter-proposals creates a negotiation thread, and wherein the proposals and counter-proposals converge over time.

9. A method as claimed in claim 8 wherein random variation is introduced to the value or timing of at least one of the proposals by the automatic agent to inhibit the other agent from calculating the predetermined function.

10. A method as claimed in claim 8 wherein the automatic agent generates further proposals only if the further proposals are within a predefined time limit for the entire negotiation thread.

11. A method as claimed in claim 10 wherein the time limit is not known by the other agent.

12. A method as claimed in claim 8 wherein the automatic agent generates further proposals only if the further proposals are within a predefined total number of proposals for that automatic agent for the entire negotiation thread.

13. A method as claimed in claim 12 wherein the total number of proposals is not known by the other agent.

14. A method as claimed in claim 1 wherein the variables further include one or more selected from the set of suggested price, suggested initial proposal, time limit for the negotiation, location of a service to which the proposal relates and quality of an item to which the proposal relates.

15. A method as claimed in claim 14 wherein the further variables are known by both the automatic agent and the other agent.

16. A method as claimed in claim 1 wherein the other agent is also an automatic agent and calculates a counter-proposal to a received proposal in accordance with a predetermined function using one or more variables, and transmits the counter-proposal to the automatic agent across a communications channel.

17. A method as claimed in claim 17 wherein the automatic agent operates within a negotiation system comprising a plurality of automatic agents and the reputation parameter is known to all automatic agents.

18. A method as claimed in claim 17 wherein the automatic agent operates within a negotiation system comprising a plurality of automatic agents and the loyalty parameter is known between the automatic agent and the other agent, and not known by the other automatic agents.

19. A method as claimed in claim 1 wherein the automatic agent is one of a plurality of agents negotiating with the another agent, and the accepted proposal for the automatic agent is a function of all final proposals from the plurality of agents.

20. A method as claimed in claim 1 wherein the automatic agent negotiates with a plurality of agents, and the accepted proposal is a function of all final proposals with the plurality of agents.

21. An automatic agent comprising:
processing circuitry configured for calculating a proposal in accordance with a predetermined function using one or more variables; wherein the variables include one or more from the set of a loyalty parameter and a reputation parameter;
storage circuitry configured for retrieving the one or more variables; and
communications circuitry for transmitting a proposal to another agent across a communications channel and receiving a counter-proposal from the other agent.

22. A computer readable storage medium on which is embedded one or more computer programs, said one or more computer programs implementing a method for generating proposals in a negotiation as claimed in claim 1.
